(19) United States
(12) Patent Application Publication
(10) Pub. No.: US 2004/0130721 A1
(43) Pub. Date: Jul. 8, 2004

(54) Method and apparatus for measuring the length of web on a bridge of a corrugator using an optical sensing device

(75) Inventors: Jun Chen, Duluth, GA (US); Brent Bowman, Atlanta, GA (US); Santosh Nayak, Atlanta, GA (US); Thomas Smith, Sierra Madre, CA (US)

Correspondence Address: HALE AND DORR, LLP, 60 STATE STREET, BOSTON, MA, 02109

(73) Assignee: Qualitek-VIB, Inc., Tucker, GA

(21) Appl. No.: 10/652,716

(22) Filed: Aug. 29, 2003

Related U.S. Application Data
(60) Provisional application No. 60/406,883, filed on Aug. 29, 2002.

(51) Int. Cl. G01N 21/84

(52) U.S. Cl. 356/429

(57) ABSTRACT

A method and apparatus for measuring the length of web in a bridge of a corrugator using an optical sensing device is disclosed. In one embodiment a variable amount of singleface web on a corrugated bridge is calibrated using a measurement of a coded moisture sequence. In another embodiment a single detector signal and an adaptive threshhold is used to detect only rapid changes of moisture content. In still another embodiment a feature of detecting the timing of a signal pattern to the pulse durations of the sprayer is used so that even as the paper speed varies the ratio of short to long remains the same.

### CROSS REFERENCE TO RELATED APPLICATIONS

This application claims benefit under 35 U.S.C. §119(e) of prior U.S. Provisional Application No. 60/406,883, entitled “Method and Apparatus to Measure the Length of Web on the Bridge of the Corrugator Using An Optical Sensing Device” filed on Aug. 29, 2002, which is incorporated herein by reference.

### BACKGROUND

In the manufacture of corrugated board, a topside sheet of paper referred to as the top liner is first bonded to a fluted sheet of paper referred to as the medium. Referring to FIG. 1, this initial fluting-and-bonding process takes place in an area of the corrugating machine 10 that is typically referred to as the singlefacer 12. The combined material exiting the singlefacer 12, which consists of the fluted medium bonded to the top liner, is typically referred to as the singleface web 14.

After the singleface web 14 is formed, it is continuously transported to a second section of the corrugator 10, called the doublebacker 16, over a length of structural support, called the bridge 18. The nature of the process requires that the singleface web 14 accumulate on the bridge 18 in the shape of festoons 14a followed by a flat run 14b of singleface web 14 to the point where it is continuously removed from the bridge 18 at the doublebacker 16. The singleface web 14 is bonded with a bottom liner to form corrugated board after it is removed from the bridge 18. Variants of this process include bonding of multiple singleface webs that are simultaneously transported over multiple bridges to be bonded at the doublebacker 16.

The purpose of the bridge 18 is to maintain a variable amount of singleface web 14 which enables running the doublebacker and the singlefacer at different speeds which is needed for the process of manufacturing corrugated board. The speed of the singlefacer 12 and the doublebacker 16 are typically measured using a 19 that rides on the paper 14 at the same speed as the paper 14. The wheel 19 is mounted on an encoder shaft 19a and the encoder shaft 19a is rotated by the wheel 19. The rotation of the encoder shaft 19a generates electrical pulses which are processed by a signal processor. Each rotation of the wheel 19 generates a fixed plurality of pulses. The circumference of the wheel 19 determines the number of pulses per unit of length. From the time computed between the start and stop of accumulation of pulses, the speed is calculated.

The method of determining the amount of variable singleface web 14 on the bridge 18 at any time is known as calibration of the bridge 18. Knowing the amount of singleface web 14 on the bridge 18 is necessary in order to maintain a desired amount on the bridge 18 and for other purposes such as changing or splicing of the individual papers at the appropriate times. Methods that have been used in the industry to calibrate the bridge 18 include:

1. The use of optical sensors (photoeyes) at multiple locations on the bridge to sense the singleface web festoons.

2. The use of wheels at multiple points on the bridge. These wheels are rotated at different rates by the singleface web based on where the festoons are on the bridge. The amount of singleface web on the bridge is determined from the relative rate of rotation of the wheels.

3. The spraying of a fluid (colored, dye, fluorescent, water) onto the singleface web at one end of the bridge and sensing of the fluid by thermal means at the doublebacker end which when considered with the speeds of the singlefacer and doublebacker will result in a calculation of the amount of singleface web on the bridge.

4. The use of metal foil tape applied on the web at the singlefacer and the detection of the metal using a metal detector at the doublebacker.

### SUMMARY OF THE INVENTION

In general, in one aspect, the invention features a method and apparatus for measuring the length of web in a bridge of a corrugator using an optical sensing device. In one embodiment a variable amount of singleface web on a corrugated bridge is calibrated using a measurement of a coded moisture sequence. In another embodiment a single detector signal and an adaptive threshhold is used to detect only rapid changes of moisture content. In still another embodiment a feature of detecting the timing of a signal pattern to the pulse durations of the sprayer is used so that even as the paper speed varies the ratio of short to long remains the same.

These and other features and objects of the present invention will be more fully understood in the following detailed description which should be read in light of the accompanying drawings in which corresponding reference numerals refer to corresponding parts throughout the several views.

### DESCRIPTION OF THE DRAWINGS

FIG. 1 is a side elevational view of a corrugator apparatus showing a singlefacer, bridge and doublebacker;

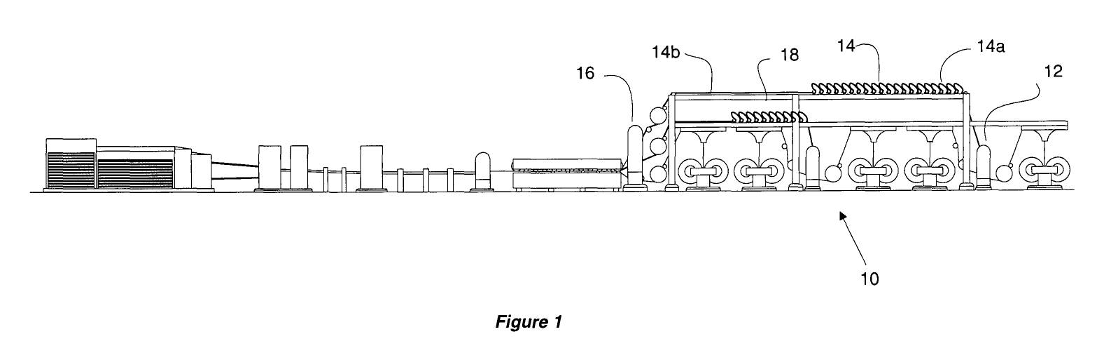

FIG. 2 is a side elevational view of a portion of the corrugator apparatus shown in FIG. 1 in which the moisture application and detection takes place;

FIG. 3 is a side elevational view of the corrugator apparatus shown in FIGS. 1 and 2 which show the placement of the optical sensor and sprayer.

FIG. 4 is a diagram of a basic infrared sensor used for detecting moisture in the corrugator apparatus of the present invention shown in FIGS. 1 and 2;

FIG. 5 is a diagram of a reflecting sensor used in an alternative embodiment of the corrugator apparatus shown in FIGS. 1 and 2;

FIG. 6 is a diagram of fiber optic probes used in still another embodiment of the corrugator apparatus shown in FIGS. 1 and 2;

FIG. 7 is a diagram of an embodiment of the present invention using multiple fiber optic probes;

FIG. 8 is a diagram of the coded moisture pattern used in the apparatus and method of the present invention;

FIG. 9 is a flow chart of the process for validating a coded moisture pattern used in the apparatus and method of the present invention.

### DESCRIPTION OF INVENTION

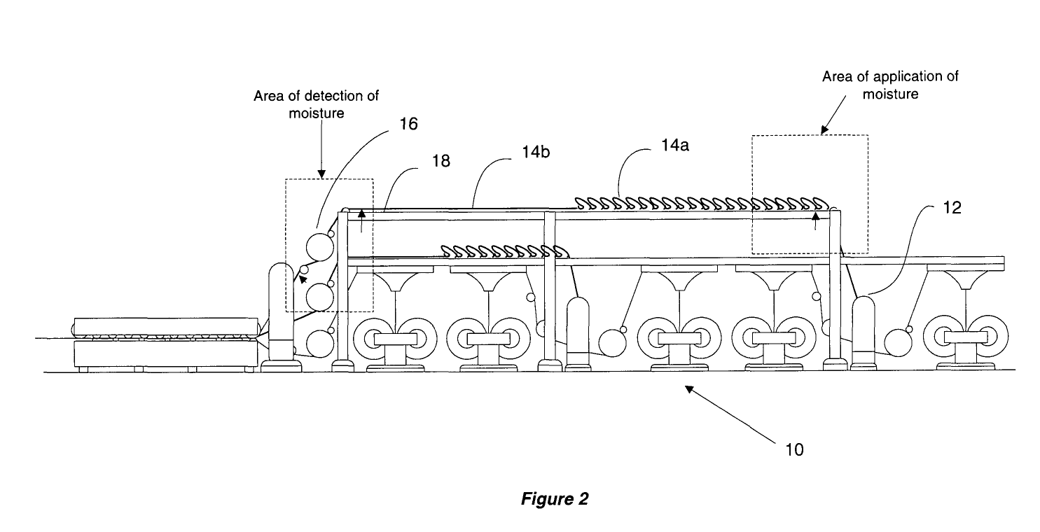

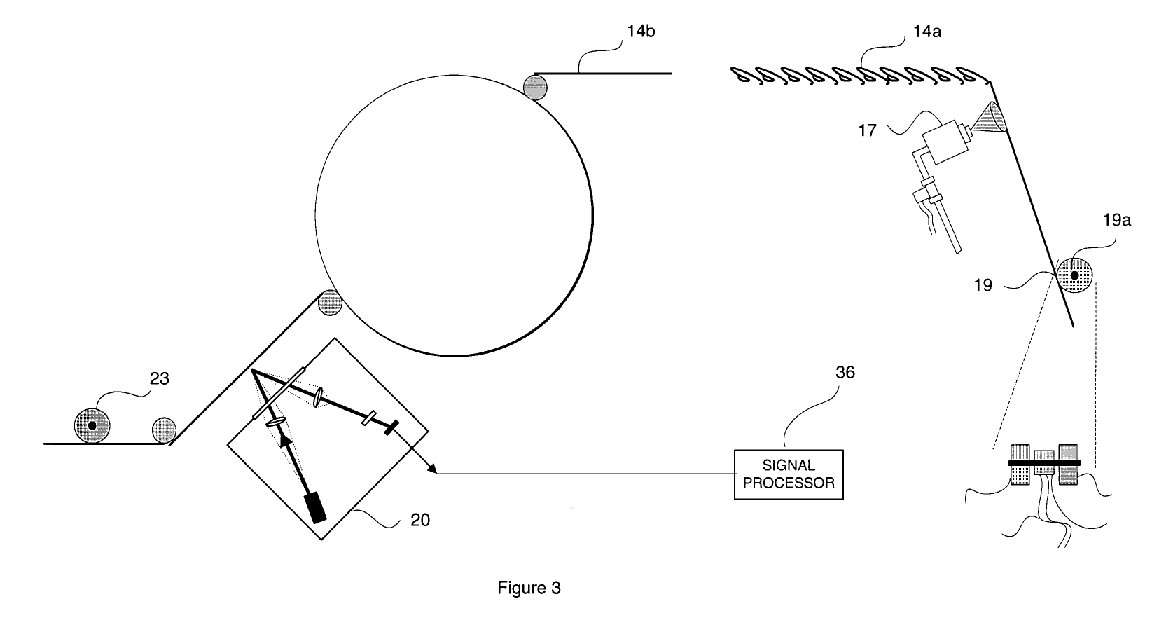

Referring to FIGS. 2 and 3, this invention is a system and process for measuring the length of a web 14 on a bridge 18 that uses a unique means for determining the amount of paper 14 on the bridge 18. The process includes the wetting of the singleface web 14 with sprayer 17 as it enters the bridge 18 at the singlefacer 12 in a coded pattern of moisture (water only) and detecting the coded moisture pattern at the doublebacker 16 using a single-wavelength optical sensor 20 sensitive to water only (no additives, fluorescent dye or colorant is required). Water without additives provides an environmentally safe marking system that requires minimum maintenance. In addition, the water quickly dissipates (evaporates) leaving no unsafe residue. The optical sensor 20 used to detect the water mark may either;

1. Detect a change of reflectance due to molecular absorption of the water. In such case, infrared operation is preferred to detect water absorption.

2. Detect a change of reflectance due to a change of light scattering from the paper fibers being filled with water. Either infrared or visible light operation would suffice to detect such light scattering. Visible detection is cheaper, but requires a higher level of moisture.

Finally, the processing of the optical sensor signals must be optimized to the coded pattern to assure a highly reliable reading. The signal from the optical sensor 20 is continuously measured and a running average signal is computed. The length of the average is long compared to the anticipated moisture pulse duration, but short compared to system drifts caused by temperature and background paper moisture variations. A threshold is set relative to the varying running average so that the threshold is “adaptive” to the large variations of background. Signals due to the sprayed moisture pattern have a small amplitude compared to the running average signal. Detecting the moisture pattern is therefore highly likely. However, the threshold signal is noisy and a form of redundancy is employed to assure a reliable detection of the applied moisture pattern. The redundancy is implemented in the form of two moisture pulses with a known ratio pulse duration. Because the ratio of the pulse durations is independent of web speed, the detection is highly reliable.

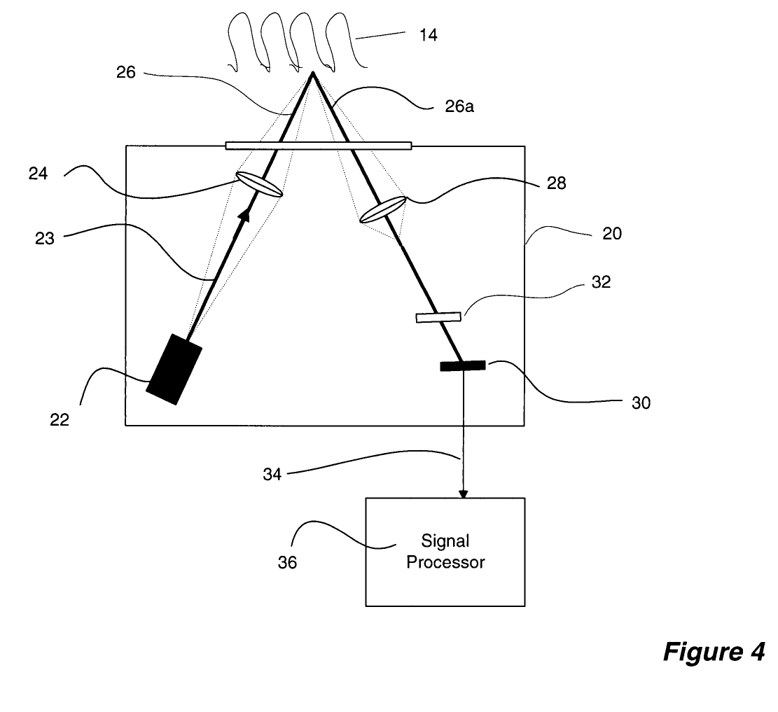

In the embodiment shown in FIG. 4, a single-wavelength diffuse reflectance sensor 20 is used that is suitable for detecting a moisture-rich segment of paper. Infrared light 23 is produced by a small filament (1 mm by 3 mm), 12 volt tungsten-halogen lamp 22. Light from the lamp 22 is collimated by a 1 inch diameter F/1 aspheric lens 24 and directed to the surface of the moving paper 14. The incident infrared light 26 scatters throughout the paper fibers, is partially absorbed by the water molecules, and a small fraction 26a of the infrared light is reflected back toward the sensor 20.

Reflected light is collected by a second lens 28, F/3, 2 inches in diameter about 6 inches from the paper 14 surface. The collection lens focuses the infrared light onto a lead-sulfide (or light sensitive) detector 30 which has over its aperture a narrow-bandpass filter 32 at 1,935 nanometers. The wavelength is selected to correspond to the strong O—H absorption of the water molecule. The Lead Sulphide detector produces an electrical signal 34 proportional to the intensity of the infrared light, thus related, via the molecular absorption, to the relative water content of the paper 14. The electrical signal 34 is sent to a signal processor 36, which in a preferred embodiment is a digital signal processor.

The optical band-pass filter 32 is selected to limit the light to a specific wavelength where the O—H molecular bond (of water) is known to absorb light. Other wavelengths where water absorbs include 980 nanometers, 1100 nanometers, and 1450 nanometers. The water absorption signal is strong at these wavelengths and the sensor 20 is able to detect small amounts of water content. For large water content (i.e., over 15% by weight) the infrared signal responds to both water absorption and scattering.

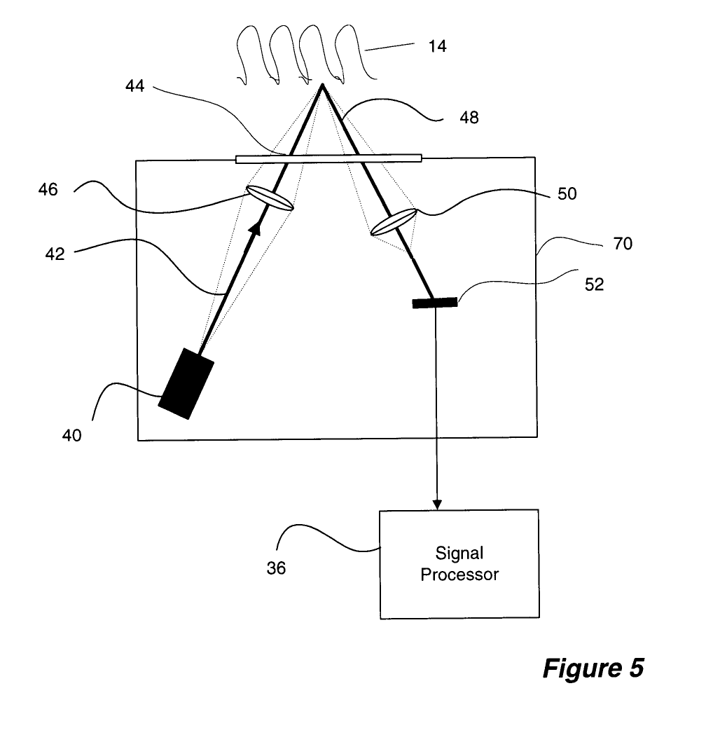

Another embodiment uses visible wavelength sensory devices that detect wavelengths from 400 nanometers to 750 nanometers. Use of a green LED (550-575 nanometers) 40 to detect a moisture-rich segment of paper 14 is illustrated in FIG. 5. Modulated light 42 from the LED 40 is directed to the surface of the moving paper 14 through focusing lens 46. The incident visible light 42 is scattered differently from the moisture-rich segment versus the normally dry singleface web. This results in a change in signal when a moisture-rich segment moves into the sensor field of view over window 44.

Reflected light 48, focused by focusing lens 50, is collected by a phototransistor 52 about 6 inches in from the paper surface. Signal processor 36 determines changes in the reflected signal which are proportional to the increase in moisture in order to detect the moisture segment.

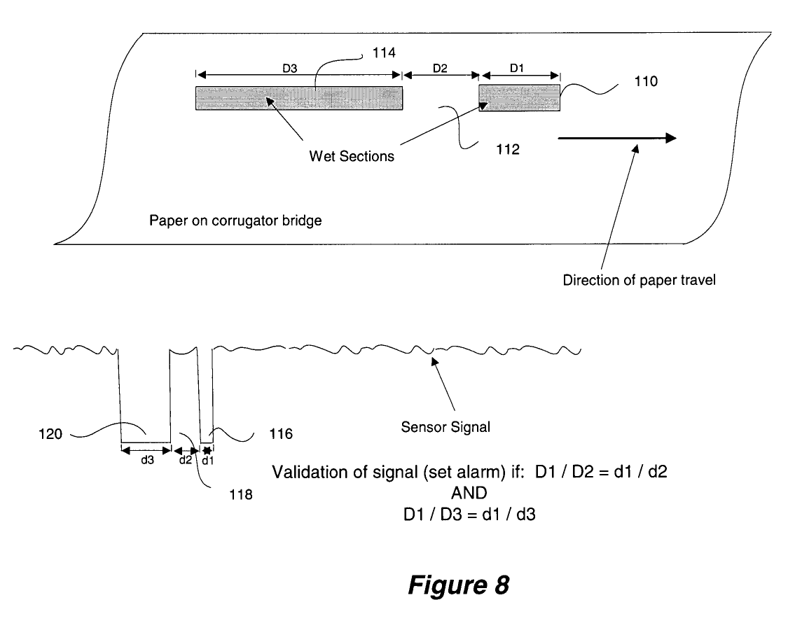

The key to reliable detection is the use of a pattern of wet and dry paper that is applied by a narrow water sprayer 17 that can be rapidly turned on and off. FIG. 8 illustrates the results of the wet and dry sections of paper and the effect on the moisture signal. For example, a short and a long spray wets the moving paper in two places, the first section 60 about 3 inches long and the second section 62 about 6 inches long. This is a function of the time for which the sprayer 17 is on and the speed at which the paper 14 is moving. As these sections 60, 62 of paper 14 pass through the field of view of the sensor, the voltage output appears as a short t1 and a long t3 signal on a slowly varying baseline. The base line is measured as a short term average and is subtracted from the real time signal. The pulses are processed by a signal processor 36 numerical algorithm that sets the alarm (validates the coded moisture pattern) only when a long pulse trails a short pulse in the exact time ratio as the applied spray. The coded pattern prevents false alarms caused by electrical noise spikes and light flashes often found in a factory environment.

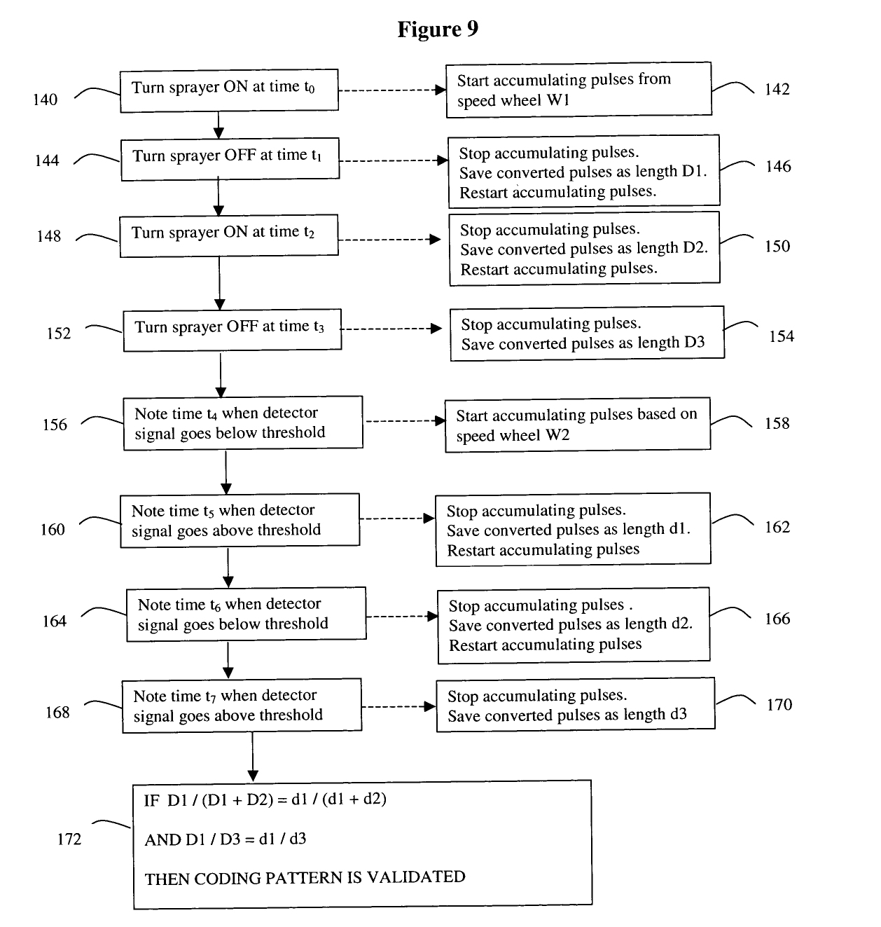

The process for validating the coded moisture pattern performed by the signal processor 36 will now be described with reference to FIGS. 8 and 9. The sprayer 17 is turned on in step 140 and an accumulator is started to accumulate the number of pulses from the encoder wheel 19 in step 142.

When the sprayer is turned off in step 144, the time difference t1−t0 which represents the length of time the sprayer was turned on is determined and is preferably between 0.25 and 0.75 seconds. The accumulation of pulses is stopped in step 146. Length D1 is computed from the number of accumulated pulses and the length per pulse. This length D1 is the length (or distance) of the first wet segment 110. The accumulator is then cleared and accumulation of pulses is restarted.

At time t2 17 sprayer is again turned on in step 148. The time difference t2−t1 for this dry section is preferably between 1 and 2 seconds. Accumulation of pulses is stopped in step 150. Length D2 is computed from the number of accumulated pulses and the length per pulse. This length D2 is the length of the dry segment 112. The accumulator is cleared and the accumulation of pulses from the speed wheel 19 is restarted in step 150.

The sprayer 17 is turned off in step 152. The time difference t3−t2 for the wet section 112 is preferably between 0.75 and 1.5 seconds. The accumulation of pulses is stopped in step 154. Length D3 is computed from the number of accumulated pulses and the length per pulse. This length D3 is the length (or distance) of the second wet segment 114.

When the first detection of the signal is observed by the sensor (signal goes below the threshold) in step 156 an accumulator is started to accumulate the number of pulses from the encoder wheel 23 in step 158.

When the signal goes above the threshold the accumulation of pulses is stopped in step 160. The length d1 is computed from the accumulated number of pulses and the length per pulse for wheel 23 in step 162. This length d1 is the length of the first measured wet segment. The accumulator is cleared and restarted using encoder wheel 23.

When the signal goes below the threshold again in step 164 the accumulation of pulses is stopped in step 166. The distance d2 is computed from the accumulated number of pulses and the length per pulse for wheel 23. This length d2 is the length of the measured dry segment. The accumulator is cleared and restarted using encoder wheel 23.

When the signal goes above the threshold in step 168 the accumulation of pulses is stopped in step 170. The length d3 is computed from the accumulated number of pulses and the length per pulse for wheel 23. This length d3 is the length of the second measured wet segment.

The coding pattern is validated if the ratio of the lengths of the first wet segment D1 divided by the length of the wet and dry segment D1 and D2 is the same as the ratio of the first measured wet segment d1 divided by the length of the measured wet and dry segments d1 and d2, AND if the ratio of lengths of the first wet segment D1 to the second wet segment D3 is the same as the ratio of lengths of the first measured wet segment d1 and the second measured wet segment d3 in step 172.

The signal 64 from the sensor 20 is processed through an adaptive digital filter where a short term history of signal strength is maintained. The number of history points used to determine the base signal level is dependent on the process noise and the level of moisture in the base paper substrate. Typically 5 to 20 points are used. The threshold that determines the presence of water is typically 20 to 30 percent of the base signal level. The threshold is a function of the affinity of the substrate to absorb the sprayed water. In order to determine the moisture pattern, the time duration for which the signal is beyond the threshold is compared for two successive excursions from the threshold. When the ratio of these two successive excursions is the same as the times for which the water was applied to the substrate 14, the validation of the moisture pattern is complete. Knowing the speeds at which the singleface web 14 entered the bridge 18 and the speed of the singleface web 14 leaving the bridge 18 and the time difference between the application of the moisture pattern and the detection of the moisture pattern determines the exact amount of singleface web 14 that is on the bridge 18.

When the spray is activated the number of pulses from the encoder wheel are accumulated. When the coded moisture pattern is detected, the accumulation of the pulses is stopped. The accumulated pulses are then converted into length using the number of pulses per unit of length. This length computation is the amount of singleface web 14 on the bridge 18.

In the simplest embodiment of the invention shown in FIG. 4, the packaging of the sensor includes a light source 20, narrow band filter 32, and detector 30 in the same apparatus mounted in a hermetically sealed enclosure at the point of detection on the bridge 18.

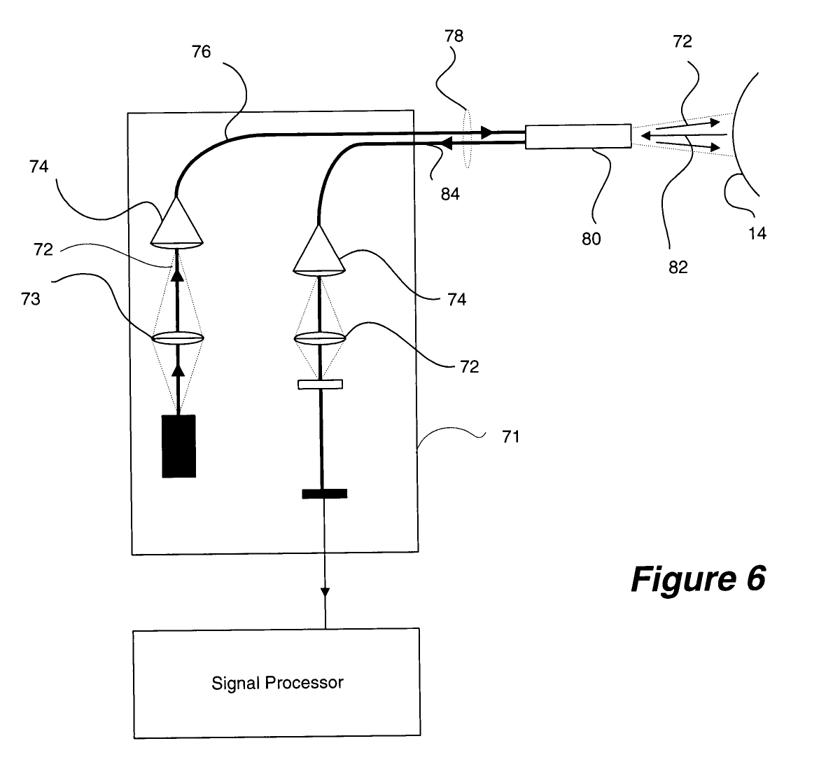

In an enhanced embodiment shown in FIG. 6, fiber optics are employed to permit remote location of the sensor's source, filter, and detectors. This arrangement removes the sensor's delicate and temperature-sensitive components from the hot, moist on-machine environment, and also reduces the size of the on-machine equipment to simplify installation and maintenance. The source light 72 is focused by lens 73 and collected by a source fiber-optic adapter 74. The source light 72 passes through fiber-optic strands 76 along the length of source fiber-optic bundle 78 to a fiber-optic probe 80. The source light 72 then issues from the fiber-optic probe 80 and illuminates the paper 14. The reflected light 82 from the paper 14 is collected by a lens 83, focused onto the end face of one or more additional fiber-optic strands 85 that are integrated into the fiber-optic probe 80, and then passes back up along a set of return fiber-optic strands 84 back into the sensor 71. The reflected light 82 is handled in the same manner as previously described with respect to the embodiment shown in FIG. 4.

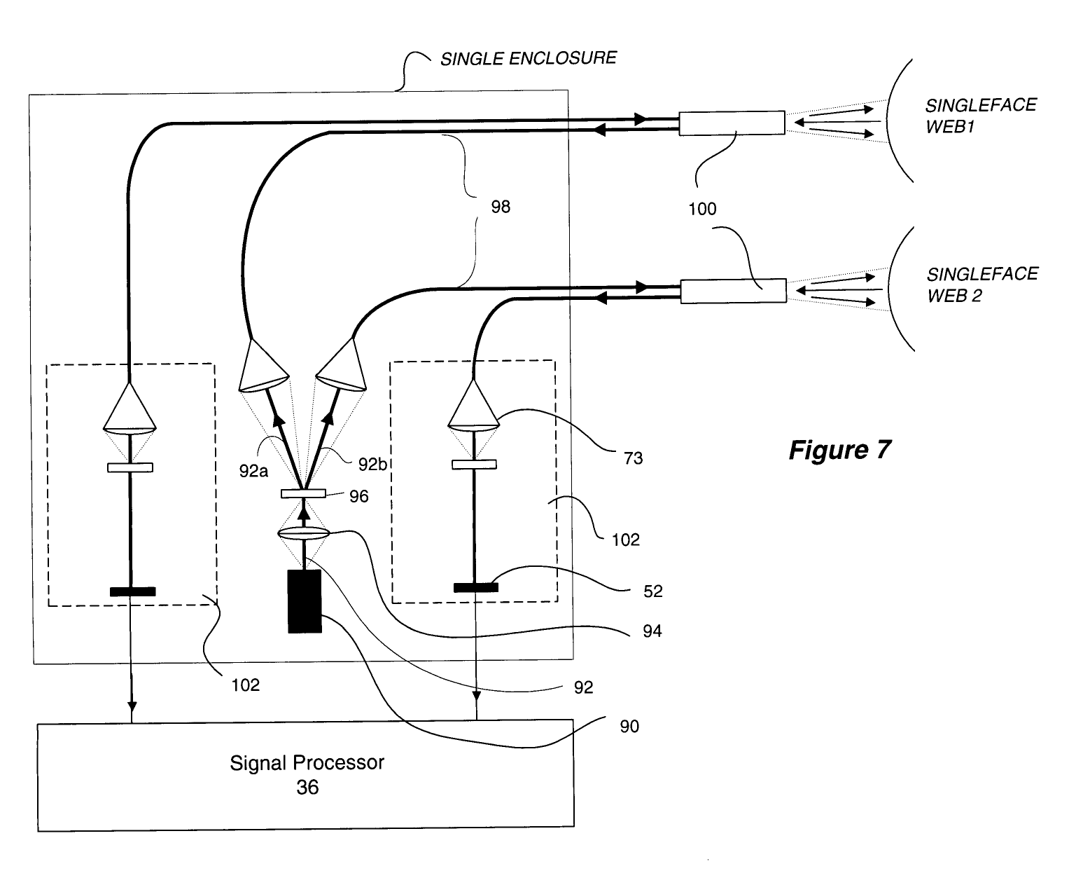

In a further enhanced embodiment shown in FIG. 7, a single light source is used for two sensing positions, with the source and return optical paths being combined within a single enclosure to essentially form a dual sensor with a shared source. The light source 90 causes light 92 to pass through a focusing lens 94 and then a beam splitter 96 to produce two separate source light beams 92a, 92b, each of which are then conducted along fiber-optic strands 98 to fiber-optic probes 100. Alternatively, a bifurcated fiber bundle could be used. One light beam then shines upon singleface web 14 on the first bridge 18 and the other on the singleface web 14 on the second bridge 18. The reflected light from each location is then conducted back into separate detector assemblies 102 to produce two separate measurements using a single light source.

Many different infrared absorption sensor configurations may be contemplated to produce the required measurements. The unique features of this invention are the following.

the use of calibrating a variable amount of singleface web on a corrugator bridge using a measurement of a coded moisture sequence

use of a single detector signal and an adaptive threshold to detect only rapid changes of moisture content

timing the detected signal pattern to the pulse durations of the sprayer. Even as the paper speed varies, the ratio of short to long remains the same.

The foregoing invention has been described with reference to its preferred embodiments. Various alterations and modifications will occur to those skilled in the art. All such alterations and modifications are intended to fall within the scope of the appended claims.

what is claimed is:

1. An apparatus for measuring the length of a web on the bridge of a corrugator, said apparatus comprising:
a sprayer for applying moisture to the web;
an optical sensor for sensing moisture applied to the web.

2. The apparatus for measuring the length of a web of claim 1 wherein said optical sensor comprises:
a light source;
a band pass filter;
a light detector;
wherein said light source, band pass filter and detector are housed together in a single housing.

3. The apparatus for measuring the length of a web of claim 2 wherein said light detector is a light detector capable of detecting infrared light reflected from the web.

4. The apparatus for measuring the length of a web of claim 2 wherein said band pass filter limits light reflected to the detector to light having a wavelength where the O—H molecular bond of water is known to absorb light.

5. The apparatus for measuring the length of a web of claim 1 wherein said optical sensor is a visible wavelength sensor.

6. The apparatus for measuring the length of a web of claim 5 further comprising a light emitting diode for directing visible light onto a web.

7. The apparatus for measuring the length of a web of claim 1 wherein said sprayer applies a coded pattern of moisture to the web.

8. The apparatus for measuring the length of a web of claim 1 further comprising fiber optic strands for carrying light to said web.

9. The apparatus for measuring the lengths of a web of claim 1 further comprising said at least one additional optical sensor.

10. The apparatus for measuring the lengths of a web of claim 9 wherein said optical sensor and said at least one additional optical sensor share the same light sensor.

11. A process for measuring the length of a web on the bridge of a corrugator, said process comprising the steps of:
applying moisture to said web at least at least two separate intervals;
detecting moisture on said web through an optical sensor;
determining the length of at least two segments of said web that contain moisture.

12. The process for measuring the length of a web of claim 11 wherein said step of determining the length of said at least two segments comprises calculating the number of pulses accumulated while moisture is detected and converting such number of pulses to a predetermined corresponding length.

13. The process for measuring the length of a web of claim 12 wherein said step of detecting moisture comprises detecting a coded moisture pattern.
